(19) United States
(12) Patent Application Publication
(10) Pub. No.: US 2012/0089390 A1
(43) Pub. Date: Apr. 12, 2012

(54) PITCH CORRECTED VOCAL CAPTURE FOR TELEPHONY TARGETS

(75) Inventors: Jeannie Yang, San Jose, CA (US); Michael Wang, Cupertino, CA (US)

(73) Assignee: Smule, Inc., Cupertino, CA (US)

(21) Appl. No.: 13/219,648

(22) Filed: Aug. 27, 2011

Related U.S. Application Data
(60) Provisional application No. 61/377,772, filed on Aug. 27, 2010.

(51) Int. Cl. G10L 11/04

(52) U.S. Cl. 704/207

(57) ABSTRACT

Vocal musical performances may be captured and pitch corrected and supplied to telephony targets such as conventional voice terminal equipment (telephone handsets, answering machines, etc.), wireless telephony devices and information services wherein particular device or subscriber targets are identifiable using telephone numbers or alphanumeric IDs (e.g., mobile phones with or without text/multimedia messaging support, VoIP terminals, answering or voicemail services, ASP-based telephony services, etc.) and/or telco or premises-based telephony equipment, such as switches, with support for customizable ringback tones. To facilitate the foregoing, techniques have been developed for capture and audible rendering of vocal performances on handheld or other portable devices using signal processing techniques suitable given the somewhat limited capabilities of such devices and in ways that facilitate efficient encoding and communication of such captured performances via ubiquitous, though bandwidth limited, wireless networks and through communication channels typical of the wired and wireless telephony networks.

### CROSS-REFERENCE TO RELATED APPLICATION(S)

The present application claims the benefit of U.S. Provisional Application No. 61/377,772, filed Aug. 27, 2010, the entirety of which is incorporated herein by reference.

### BACKGROUND

1. Field of the Invention

The invention(s) described herein relate generally to capture and processing of vocal performances and, in particular, to techniques suitable for capture and supply of pitch corrected vocals to telephony targets.

2. Description of the Related Art

The installed base of mobile phones and other portable computing devices grows in sheer number and computational power each day. Hyper-ubiquitous and deeply entrenched in the lifestyles of people around the world, they transcend nearly every cultural and economic barrier. Computationally, the mobile phones of today offer speed and storage capabilities comparable to desktop computers from less than ten years ago, rendering them surprisingly suitable for real-time sound synthesis and other musical applications. Partly as a result, some modern mobile phones, such as the iPhone™ handheld digital device, available from Apple Inc., support audio and video playback quite capably.

Like traditional acoustic instruments, mobile phones can be intimate sound producing devices. However, by comparison to most traditional instruments, they are somewhat limited in acoustic bandwidth and power. Nonetheless, despite these disadvantages, mobile phones do have the advantages of ubiquity, strength in numbers, and ultramobility, making it feasible to (at least in theory) bring together artists for jam sessions, rehearsals, and even performance almost anywhere, anytime. The field of mobile music has been explored in several developing bodies of research. See generally, G. Wang, Designing Smule's iPhone Ocarina, presented at the 2009 on New Interfaces for Musical Expression, Pittsburgh (June 2009). Moreover, recent experience with applications such as the Smule Ocarina™ and Smule Leaf Trombone: World Stage™ has shown that advanced digital acoustic techniques may be delivered in ways that provide a compelling user experience.

As digital acoustic researchers seek to transition their innovations to commercial applications deployable to modern handheld devices such as the iPhone® handheld and other platforms operable within the real-world constraints imposed by processor, memory and other limited computational resources thereof and/or within communications bandwidth and transmission latency constraints typical of wireless networks, significant practical challenges present. Improved techniques and functional capabilities are desired.

### SUMMARY

It has been discovered that, despite practical limitations imposed by mobile device platforms, wireless data transport and applications, vocal musical performances may be captured and pitch corrected and supplied to telephony targets such as conventional voice terminal equipment (telephone handsets, answering machines, etc.), wireless telephony devices and information services wherein particular device or subscriber targets are identifiable using telephone numbers or alphanumeric IDs (e.g., mobile phones with or without text/multimedia messaging support, VoIP terminals, answering or voicemail services, ASP-based telephony services, etc.) and/or telco or premises-based telephony equipment, such as switches, with support for customizable ringback tones. To facilitate the foregoing, techniques have been developed for capture and audible rendering of vocal performances on handheld or other portable devices using signal processing techniques suitable given the somewhat limited capabilities of such devices and in ways that facilitate efficient encoding and communication of such captured performances via ubiquitous, though bandwidth limited, wireless networks and through communication channels typical of the wired and wireless telephony networks.

In some cases, the to-be-pitch-corrected vocal performances are captured at a portable computing device in the context of a karaoke-style presentation of lyrics in correspondence with audible renderings of versions of backing tracks. In some cases, backing audio simulates an ambient environment (e.g., in some cases, an environment other than that in which that vocal capture actually occurs). A telephony line identifier (e.g., a phone number, VIOP subscriber ID, etc.) is used to select a telephony target to which (or at which) the captured pitch corrected vocal performance will be rendered and is typically supplied in connection with an encoding of the captured pitch corrected vocal performance. In some cases, audio snippets may be selected from a palette or soundboard thereof for mix with the captured pitch corrected vocal performance. Often, pitch corrected vocals are encoded for upload to a server which, in turn, mixes with a version of the backing audio and directs encoded audio to the telephony target. In some cases, both capture and mix for supply can be performed at the portable device and supplied therefrom into an appropriate communications network (including via VoIP call delivery services, mobile operator networks, the PSTN or the Internet) for delivery to the telephony target. Typically, pitch corrected vocals are mixed with backing audio and encoded (at a hosted content or telephony service platform or at the portable computing device itself) for supply into telephony networks as μ-law PCM encoded audio, such as in a μ-law PCM encoded WAV file.

In some embodiments of the present invention, a method includes (1) audibly rendering, at a portable computing device, a first encoding of backing audio and, concurrently with said audible rendering, capturing and pitch correcting a vocal performance of a user; and (2) transmitting from the portable computing device to a remote server, via a wireless data communications interface, both (i) an audio encoding of the pitch corrected vocal performance and (ii) a particular voice telephony line identifier to which the pitch corrected vocal performance is to be subsequently supplied.

In some embodiments, the method further includes mixing, at the remote server, the pitch corrected vocal performance with a second encoding of the backing audio to produce a mixed performance for supply to the particular voice telephony line. In some embodiments, the mixing is performed at the portable computing device and prior to the transmitting.

In some embodiments, user interface gestures selective for an audio snippet or effect are captured at the portable computing device and an identifier for the selected audio snippet or effect keyed to a temporal position in the audio encoding is included in the transmission from the portable computing device to a remote server. In some cases, a selected audio snippet or effect may be mixed with, and included in, the transmitted audio encoding at a temporal position consistent with the user interface gesture selection.

In some embodiments, the method includes initiating, from the remote server, call delivery to the particular voice telephony line using the mixed performance as audio content of the to be delivered call. In some cases, the audio content is delivered to voice terminal equipment, a wireless telephony device and/or an answering machine or information service using a telephone number or alphanumeric subscriber identifier. In some cases, the audio content is delivered to telco or premises-based telephony equipment for supply as a ringback tone for calls subsequently initiated to the telephony target.

In some embodiments, the method includes uploading, from the remote server, a mixed performance for subsequent rendering as a ring-back tone in a telephone call incoming from the particular voice telephony line as calling party. In some cases, subsequent rendering as a ring-back tone is by a switch servicing either or both of a called party and the particular voice telephony line as calling party. In some cases, the called party is a user of the portable computing device.

In some embodiments, the method further includes initiating a text or multimedia message to the particular voice telephony line, the text or multimedia message including a resource locator by which the mixed performance may be retrieved by a recipient thereof.

In some embodiments, the method further includes transcoding, at the remote server, the audio encoding transmitted from the portable computing device into a μ-law or A-law PCM encoding format suitable for interchange with a public switched telephone network (PSTN) switch. In some embodiments, the transcoding is performed at the portable computing device prior to the transmitting. In some embodiments, transcoding (either at the remote server or the portable computing device) is into an encoding format suitable for interchange with a voice over internet protocol (VoIP) call delivery service.

In some embodiments, the method further includes, as a preview and prior to the subsequent supply, audibly rendering at the portable computing device a first mix of the pitch corrected vocal performance with either the first or the second encoding of the backing track.

In some cases, pitch correction setting are retrieved via the data communications interface. In some cases, the retrieved settings include pitch correction settings characteristic of a particular artist. In some cases, the retrieved settings include performance synchronized temporal variations in pitch correction settings synchronized with backing audio. In some cases, the retrieved settings include include score-coded note targets.

In some embodiments, the method further includes (1) retrieving via the data communications interface either or both of (i) the first encoding of the backing audio and (ii) lyrics and timing information associated with the backing audio; and (2) concurrent with the audible rendering, presenting corresponding portions of the lyrics on a display of the portable computing device in accord with the timing information.

In some embodiments, the method further includes receiving and audibly rendering a first mixed performance at the portable computing device, wherein the first mixed performance is an encoding of the pitch corrected vocal performance mixed with the higher quality or fidelity second encoding of the backing audio. In some cases, backing audio includes a backing track of instrumentals and/or vocals or a backing track of ambient sounds reminiscent of a place other that in which the portable computing device presently resides.

In some embodiments, the portable computing device is a mobile phone, a personal digital assistant or a laptop computer, notebook computer, pad-type device or netbook. In some case, the method is provided in tangible form as a computer program product encoded in one or more media, the computer program product including instructions executable on a processor of the portable computing device to cause the portable computing device to perform any of the aforementioned methods.

In some embodiments of the present invention, a portable computing device includes a display; a microphone interface; an audio transducer interface; a data communications interface; media content storage coupled to receive via the data communication interface, and to thereafter supply for audible rendering via the audio transducer interface, a first encoding of backing audio; continuous pitch correction code executable on the portable computing device to, concurrent with said audible rendering, pitch correct a vocal performance of a user captured using the microphone interface; and user interface code executable on the portable computing device to capture user interface gestures selective for a particular voice telephony line identifier to which the pitch corrected vocal performance is to be supplied and to thereafter initiate transmission of an audio encoding of the pitch corrected vocal performance.

In some embodiments, the portable computing device further includes transmit code executable on the portable computing device to effectuate the transmission via the data communications interface, the transmission including both (i) the particular voice telephony line identifier and (ii) the audio encoding for subsequent supply to the particular voice telephony line. In some cases, the transmission is to a remote server configured to subsequently supply the pitch corrected vocal performance to the particular voice telephone line. In some cases, the transmission is to a voice over internet protocol (VoIP) call delivery service. In some cases, the transmission includes a transcoding of the audio encoding into a μ-law or A-law PCM encoding format suitable for interchange with a public switched telephone network (PSTN) switch. In some cases, the transmission initiates or requests provisioning of a switch servicing either or both of a called party and the particular voice telephony line as calling party, the provisioning causing the switch to supply the audio encoding as a ring-back tone in a telephone call incoming from the particular voice telephony line as the calling party.

In some embodiments, the portable computing device further includes user interface code executable to capture user gestures selective for an audio snippet or effect and audio mixing code executable on the portable computing device to mix with, and include in, the transmitted audio encoding the selected audio snippet or effect at a temporal position consistent with the user interface gesture selection.

In some embodiments, the portable computing device further includes user interface code executable to capture user gestures selective for an audio snippet or effect and the transmission includes an identifier for the selected audio snippet or effect keyed to a temporal position in the audio encoding.

In some embodiments, the portable computing device further includes audio mixing code executable on the portable computing device to mix with, and include in, the transmitted audio encoding, the backing audio.

In some embodiments of the present invention, a method includes using a portable computing device for vocal performance capture, the handheld computing device having a display, a microphone interface and a data communications interface; retrieving from the data communications interface, either or both of a first encoding of backing audio and (ii) lyrics and timing information associated with the backing audio; audibly rendering the first encoding of backing audio and, concurrently with said audible rendering, capturing and pitch correcting a vocal performance of a user; and transmitting via the data communications interface, both (i) an audio encoding of the pitch corrected vocal performance and (ii) a particular voice telephony line identifier to which the pitch corrected vocal performance is to be subsequently supplied.

In some embodiments, the method further includes, prior to the transmitting, mixing the pitch corrected vocal performance with the first encoding of the backing audio to produce a mixed performance version of the audio encoding for supply to the particular voice telephony line. In some embodiments, the method includes capturing, at the portable computing device, user interface gestures selective for an audio snippet or effect; and including in the transmission an identifier for the selected audio snippet or effect keyed to a temporal position in the audio encoding. In some embodiments, the method includes capturing, at the portable computing device, user interface gestures selective for an audio snippet or effect; and mixing with, and including in, the transmitted audio encoding the selected audio snippet or effect at a temporal position consistent with the user interface gesture selection.

In some embodiments, the method further includes transcoding, at the portable computing device and prior to the transmitting, the audio encoding into a p-law or A-law PCM encoding format suitable for interchange with a public switched telephone network (PSTN) switch. In some cases, the transmitting is to a remote server configured to subsequently supply the pitch corrected vocal performance to the particular voice telephone line. In some cases, the transmitting is to a voice over internet protocol (VoIP) call delivery service. In some cases, the transmission initiates or requests provisioning of a switch servicing either or both of a called party and the particular voice telephony line as calling party, the provisioning causing the switch to supply the audio encoding as a ring-back tone in a telephone call incoming from the particular voice telephony line as the calling party.

These and other embodiments in accordance with the present invention(s) will be understood with reference to the description and appended claims which follow.

### BRIEF DESCRIPTION OF THE DRAWINGS

The present invention is illustrated by way of example and not limitation with reference to the accompanying figures, in which like references generally indicate similar elements or features.

FIG. 1 depicts information flows between an illustrative mobile phone-type portable computing device, a content server and telephony targets in accordance with some embodiments of the present invention.

FIGS. 2A and 2B illustrate variations on use of hosted content service platforms and related information flows in accord with respective embodiments of the present invention.

FIG. 3 is a flow diagram illustrating signal processing at an illustrative mobile phone-type portable computing device to provide real-time continuous pitch-correction and optional harmony generation for a captured vocal performance in accordance with some embodiments of the present invention.

FIG. 4 is a functional block diagram of hardware and software components executable at an illustrative mobile phone-type portable computing device to facilitate real-time continuous pitch-correction and optional harmony generation for a captured vocal performance in accordance with some embodiments of the present invention.

FIG. 5 presents, in flow diagrammatic form, a signal processing PSOLA LPC-based harmony shift architecture in accordance with some embodiments of the present invention.

FIG. 6 illustrates features of a mobile device that may serve as a platform for execution of software implementations in accordance with some embodiments of the present invention.

FIG. 7 is a network diagram that illustrates cooperation of exemplary devices in accordance with some embodiments of the present invention.

Skilled artisans will appreciate that elements or features in the figures are illustrated for simplicity and clarity and have not necessarily been drawn to scale. For example, the dimensions or prominence of some of the illustrated elements or features may be exaggerated relative to other elements or features in an effort to help to improve understanding of embodiments of the present invention.

### DESCRIPTION

Techniques have been developed to facilitate (1) the capture, pitch correction, harmonization of vocal performances on handheld or other portable computing devices and (2) the mixing and encoding of such pitch-corrected and/or harmonized vocal performances for rendering on or via telephony targets such as voice terminal equipment, answering machines or services, ringback tone facilities of telco switching or private exchange infrastructure, etc. Implementations of the described techniques employ signal processing techniques and allocations of system functionality that are suitable given the generally limited capabilities of such handheld or portable computing devices and that facilitate efficient encoding and communication of the pitch-corrected/harmonized vocal performances (or precursors or derivatives thereof) via wireless and/or wired bandwidth-limited networks for rendering on or via telephony targets.

In some cases, the developed techniques build upon vocal performance capture, continuous, real-time pitch detection and correction technologies and upon encoding/transmission of such pitch corrected vocals to a content server where, in some embodiments, they may be mixed with backing audio (e.g., instrumentals, vocals, ambients, etc.) and encoded for delivery to telephony targets through telephony networks (including PSTN, wireless, internet/VoIP networks and combinations thereof). In some embodiments, mixing, encoding and even introduction of the pitch-corrected audio into telephony networks may be performed at (or from) the portable computing device itself. In some embodiments, a portable computing device such as a handheld mobile phone coordinates (or at least initiates) supply from a hosted content service that stages, mixes and encodes for telephony targets the audio that includes the caputured and pitch corrected vocals.

In some multi-technique implementations, pitch detection builds on time-domain pitch correction techniques that employ average magnitude difference function (AMDF) or autocorrelation-based techniques together with zero-crossing and/or peak picking techniques to identify differences between pitch of a captured vocal signal and score-coded target pitches. Based on detected differences, pitch correction based on pitch synchronous overlapped add (PSOLA) and/or linear predictive coding (LPC) techniques allow captured vocals to not only be pitch corrected in real-time to “correct” notes in accord with a score, but also to be augmented with pitch-shifted variants of the captured vocals in accord with score-coded harmonies. In some embodiments, pitch correction may be based on techniques that computationally simplify autocorrelation calculations as applied to a variable window of samples from a captured vocal signal, such as with plug-in implementations of Autotune® technology popularized by, and available from, Antares Audio Technologies.

### Karaoke-Style Vocal Performance Capture

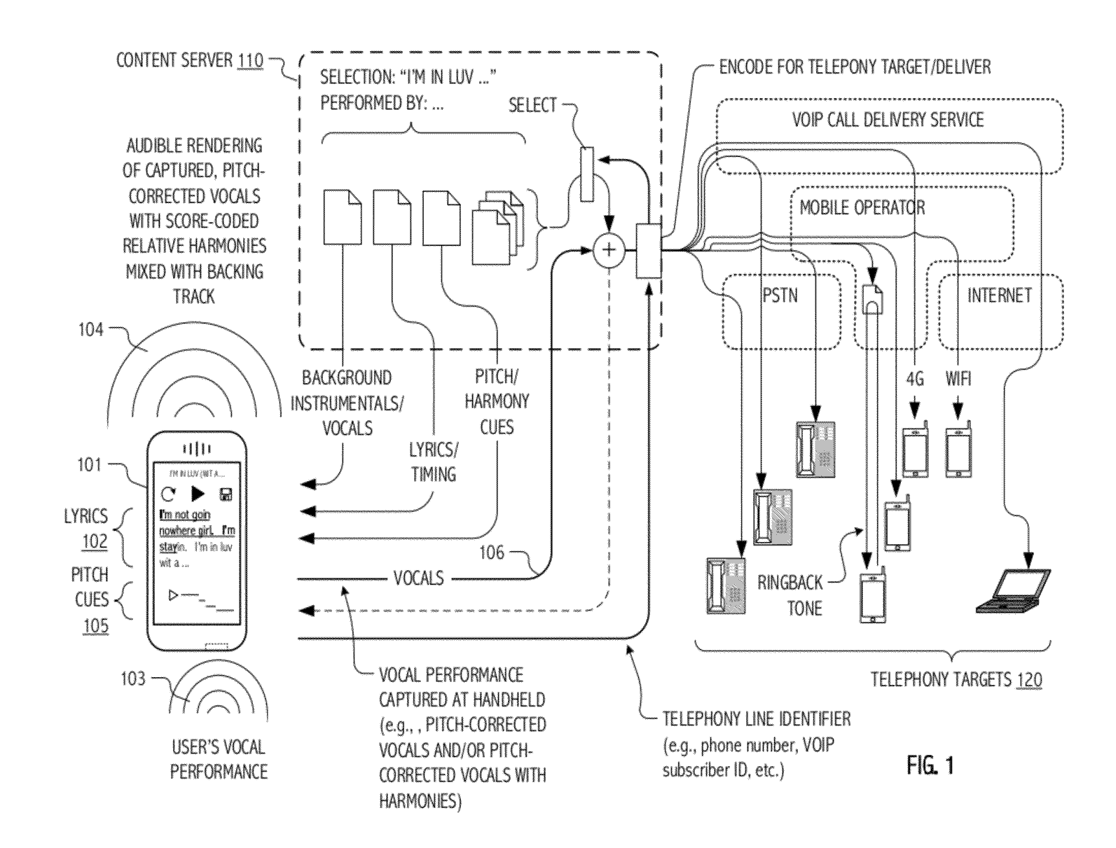

Although embodiments of the present invention are not necessarily limited thereto, mobile phone-hosted, pitch-corrected, karaoke-style, vocal capture provides a useful descriptive context. For example, in some embodiments such as illustrated in FIG. 1, an iPhone™ handheld available from Apple Inc. (or more generally, handheld 101) hosts software that executes in coordination with a content server to provide vocal capture and continuous real-time, score-coded pitch correction and harmonization of the captured vocals. As is typical of karaoke-style applications (such as the “I am T-Pain” application for iPhone originally released in September of 2009 or the later “Glee” application, both available from Smule, Inc.), a backing track of instrumentals and/or vocals can be audibly rendered for a user/vocalist to sing against. In such cases, lyrics may be displayed (102) in correspondence with the audible rendering so as to facilitate a karaoke-style vocal performance by a user. In some cases or situations, backing audio may be rendered from a local store such as from content of an iTunes™ library resident on the handheld.

User vocals 103 are captured at handheld 101, pitch-corrected continuously and in real-time (again at the handheld) and audibly rendered (see 104, mixed with the backing track) to provide the user with an improved tonal quality rendition of his/her own vocal performance. Pitch correction is typically based on score-coded note sets or cues (e.g., pitch and harmony cues 105), which provide continuous pitch-correction algorithms with performance synchronized sequences of target notes in a current key or scale. In addition to performance synchronized melody targets, score-coded harmony note sequences (or sets) provide pitch-shifting algorithms with additional targets (typically coded as offsets relative to a lead melody note track and typically scored only for selected portions thereof) for pitch-shifting to harmony versions of the user's own captured vocals. In some cases, pitch correction settings may be characteristic of a particular artist such as the artist that performed vocals associated with the particular backing track.

In the illustrated embodiment, backing audio (here, one or more instrumental and/or vocal tracks), lyrics and timing information and pitch/harmony cues are all supplied (or demand updated) from one or more content servers or hosted service platforms (here, content server 110). For a given song and performance, such as “I'm in Luv (with a . . . )”, several versions of the background track may be stored, e.g., on the content server. For example, in some implementations or deployments, versions may include:
uncompressed stereo way format backing track,
uncompressed mono way format backing track and
compressed mono m4a format backing track.
   In addition, lyrics, melody and harmony track note sets and related timing and control information may be encapsulated as a score coded in an appropriate container or object (e.g., in a Musical Instrument Digital Interface, MIDI, or Javascript Object Notation, json, type format) for supply together with the backing track(s). Using such information, handheld 101 may display lyrics and even visual cues related to target notes, harmonies and currently detected vocal pitch in correspondence with an audible performance of the backing track(s) so as to facilitate a karaoke-style vocal performance by a user.

Thus, if an aspiring vocalist selects on the handheld device “I'm in Luv (with a . . . )” as originally popularized by the artist T-Pain, iminluv.json and iminluv.m4a may be downloaded from the content server (if not already available or cached based on prior download) and, in turn, used to provide background music, synchronized lyrics and, in some situations or embodiments, score-coded note tracks for continuous, real-time pitch-correction shifts while the user sings. Optionally, at least for certain embodiments or genres, harmony note tracks may be score coded for harmony shifts to captured vocals. Typically, a captured pitch-corrected (and possibly harmonized) vocal performance is saved locally on the handheld device as one or more way files and is subsequently compressed (e.g., using a lossless Apple Lossless Encoder, ALE, lossy Advanced Audio Coding, AAC, or vorbis codec) and encoded for upload (106) to the content server as an MPEG-4 audio, m4a, or ogg container file. MPEG-4 is an international standard for the coded representation and transmission of digital multimedia content for the Internet, mobile networks and advanced broadcast applications. OGG is an open standard container format often used in association with the vorbis audio format specification and codec for lossy audio compression. Other suitable codecs, compression techniques, coding formats and/or containers may be employed if desired.

In some embodiments, a corresponding μ-law PCM encoded WAV file (or other telephony network friendly encoding) is prepared at the content server from the uploaded m4a or ogg content for subsequent supply to one or more telephony targets. In some embodiments, the μ-law PCM encoded WAV (or other telephony network friendly encoding) is prepared at the handheld device, e.g., from precursor way, m4a or ogg/vorbis content, and supplied therefrom (or staged at a content server for supply) into a telephone network or to a call delivery service via handheld resident application programming interfaces (APIs).

Depending on the implementation, encodings of dry vocals, pitch-corrected vocals and/or pitch-corrected vocals with harmonies may be uploaded to the content server. In general, such vocals with pitch-correction and/or harmonies (encoded, e.g., as way, m4a, ogg/vorbis content or otherwise) can then be mixed (e.g., with backing audio) to produce files or streams of quality or coding characteristics selected accord with capabilities or limitations a particular telephony target or network. As before, a Haw PCM (or other telephony network friendly encoding) of the selectively mixed content is generally preferred.

In some embodiments, such as where high-quality backing audio is available at content server 110 (e.g., as linear PCM WAV), the encodings of vocals with pitch-correction and/or harmonies may be transcoded to the higher-quality format (e.g., from ogg/vorbis to linear PCM WAV) prior to preparation of an encoding of the mix for telephony targets. In some cases, it may be acceptable to mix lower quality sources. Mixed content is subsequently transcoded (e.g., from linear PCM) to a telephony network friendly encoding (in the North America and Japan, typically a μ-law PCM encoding) and supplied into the telephony network(s). A-law PCM may be preferred in some telephony networks, e.g., in Europe and elsewhere.

In some embodiments, particularly those in which a VoIP call delivery service platform provides an interface into telephony network(s), the mixed content may be supplied as a file (e.g., as a μ-law PCM encoded WAV file) or as resource locator (e.g., a URL) therefor. In some cases, transcoding facilities at the VoIP call delivery service platform may be leveraged and the supplied file may be otherwise coded (e.g., as a linear PCM WAV or MP3 file) for transcode at the service platform. In some cases, third party service platforms may employ non-standard or proprietary interchange formats and, based on the description herein, persons of ordinary skill in the art will appreciate suitable adaptations to rendering pipes to transcode to (or otherwise provide) suitably-coded, mixed content. Also, in some embodiments, particularly those in which the mixed content may be supplied to non-telephony targets or in which stored pitch-corrected vocal mixes are stored (e.g., to support social networking features or facilities) telephony network friendly encodings (e.g., μ-law PCM) may be transcoded from intermediate or stored forms such as the lossy AAC coding, in an MP4 container, which is the “native” format for music on iPhone and iPod Touch handhelds.

### Telephony Targets

FIG. 1 illustrates a variety of telephony targets for encodings of a vocal performance captured, pitch-corrected and/or harmonized at handheld mobile phone 101. A telephony line identifier (e.g., a phone number, VIOP subscriber ID, etc.) is used to select a particular telephony target to which (or at which) the captured pitch-corrected vocal performance will be rendered. Of course, multiple telephony line identifiers may be used to select multiple telephony targets to (or at) which a pitch-corrected vocal performance is to be rendered. Typically, a telephony line identifier is entered or selected by the user of handheld mobile phone 101 (e.g., from contacts or phone book/log entries available thereon) and, in some embodiments such as that illustrated, is supplied to content server 110 in connection with an encoding of the captured pitch-corrected vocal performance. The telephony line identifier provides content server 110 with information sufficient to identify (in its interactions with call delivery services or networks) one or more of the illustrated telephony targets 120 for rendering of the pitch-corrected vocal performance.

As used herein, the term “telephony target” has broad scope. In general, telephony targets may include conventional voice terminal equipment (e.g., wired telephone handsets, answering machines, etc.) and wireless telephony devices (e.g., mobile phones with or without text/multimedia messaging support, wireless voice over internet protocol (VoIP) handsets, etc.) and computers that host VoIP clients such as those popularized by Skype Limited and Vonage Marketing LLC. In addition, in some implementations or embodiments, telephony targets may include information services wherein particular device or subscriber targets are identifiable using telephone numbers or alphanumeric IDs (e.g., answering or voicemail services, ASP-based telephony services, etc.). In some cases, a telephony target may be reachable on a line serviced by telco or premises-based telephony equipment, such as switches, with support for customizable ringback tones.

As illustrated in FIG. 1, network transport pathways to a given telephony target may include any of a variety of technologies, operators and networks. Accordingly, characteristics of communication channels employed, band limits, compression and coding schemes employed may vary depending on the particular telephony target selected and, in some cases, the particular call delivery interface used to delivery audio content. Accordingly, depending on the interface(s) presented to content server 110 and/or the capabilities of a particular telephony target (if known) or particular transport pathways thereto, a particular encoding form and, indeed particular sources (e.g., backing audio encoding forms) may be selected for mix. For example, while supplying pitch-corrected vocals mixed with backing audio as file or other container (e.g., as a μ-law PCM WAV file) may be desirable for calls intiated to telephony targets via some VoIP call delivery services, other delivery interfaces may require other interface codings. In the case of calls intiated to telephony targets via public switched telephone network inferfaces, Haw or A-law PCM may be introduced directly into digital networks. Likewise, calls intiated to telephony targets via wireless operator networks, specialized air-interface encodings (such as may be supplied from a Vector Sum Excitation Linear Predictive (VSELP), Adaptive Codebook Excitation Linear Predictive (ACELP) or other appropriate codec) may be employed.

As will be appreciated by persons of ordinary skill in the art based on the present description, the term “content server” is intended to have broad scope, encompassing not only a single physical server that hosts audio content and functionality described and illustrated herein, but also collections of server or service platforms that together host the audio content and functionality described. For example, in some embodiments, content server 110 is implemented (at least in part) using hosted storage services such as popularized by platforms such as the Amazon Simple Storage Service (S3) platform. Functionality, such as mixing of backing audio with captured-pitch corrected vocals, selection of appropriate source or target audio coding forms or containers and introduction of appropriately coded audio into call delivery networks, etc. may itself by hosted on servers or service/compute platforms.

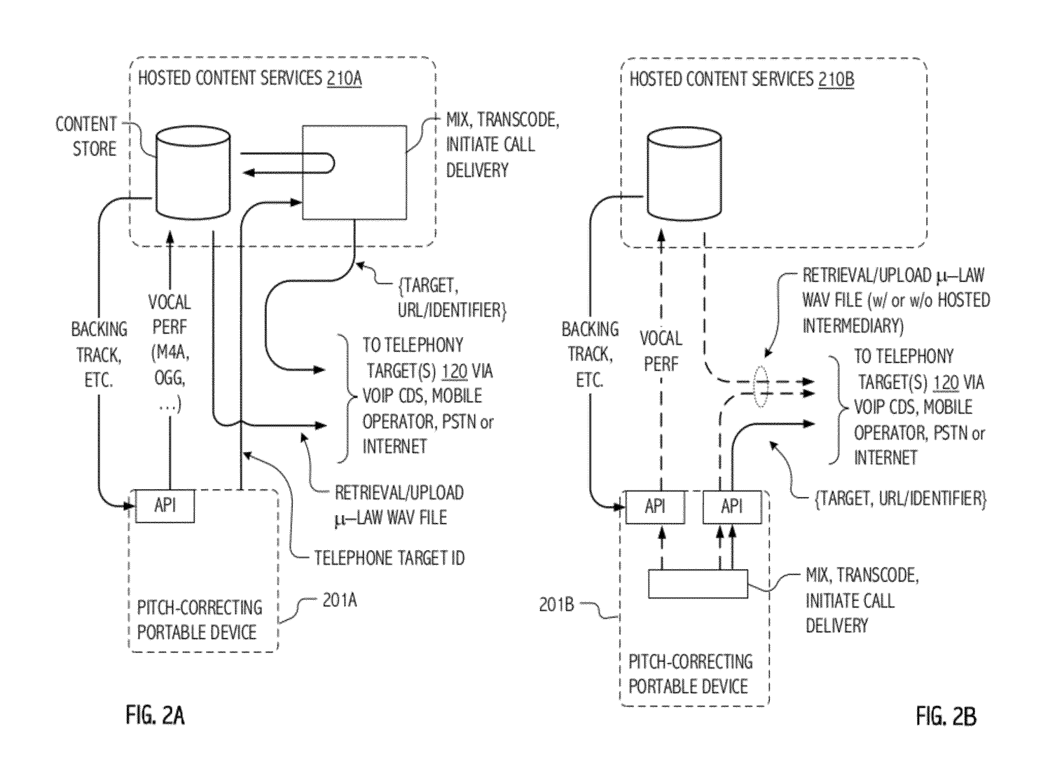

Alternatively or in addition, at least some of that functionality may be implemented at the portable computing device (e.g., an iPhone handheld suitably programmed as described herein) at which vocal capture and pitch correction are also performed. In this regard, FIGS. 2A and 2B illustrate allocations of functionality (and corresponding information flows) in respective exemplary embodiments. In particular, FIG. 2A illustrates a configuration in which hosted content storage 210A receives vocal performance codings from a pitch correcting portable device 201A (e.g., an iPhone handheld suitably programmed as described herein) and hosted functionality, in turn, mixes appropriate backing audio, transcodes as necessary or desirable for a particular telephony target 120 or network interface and initiates call delivery. FIG. 2B on the other hand, illustrates a configuration in which hosted content storage 210B acts as a staging area, receiving vocal performance codings from pitch correcting portable device 201B (e.g., an iPhone handheld suitably programmed as described herein), but in which the handheld coordinates supply of the vocal performance codings and call initiation. In some configurations in accord with FIG. 2B, mixing with appropriate backing audio, transcoding as necessary or desirable for a particular telephony target 120 or network interface and call initiation may all be performed at the handheld. In configurations consistent with either FIG. 2A or 2B, it will be appreciated that call delivery may be scheduled for a particular date and/or time or to coincide with some other triggering event.

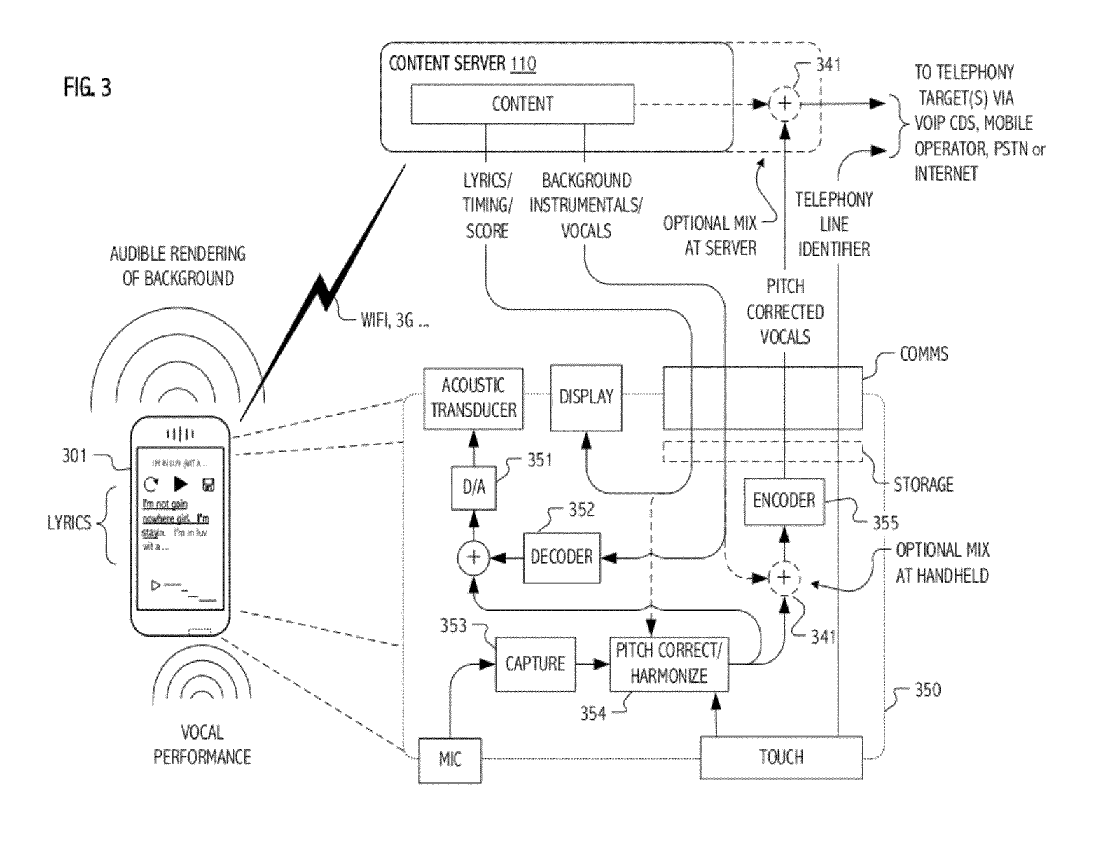

FIG. 3 is a flow diagram illustrating signal processing at an illustrative handheld device to provide real-time continuous pitch-correction and optional harmony generation for a captured vocal performance in accordance with some embodiments of the present invention. The illustration of FIG. 3 depicts as design alternatives, both handheld device-centric mixing (341) and content server-centric mixing (342), although persons of ordinary skill in the art will recognize that implementations need not implement both. In either case, handheld 301 initiates calls to telephony targets using a telephony line identifier.

### Optional Score-Coded Harmony Generation

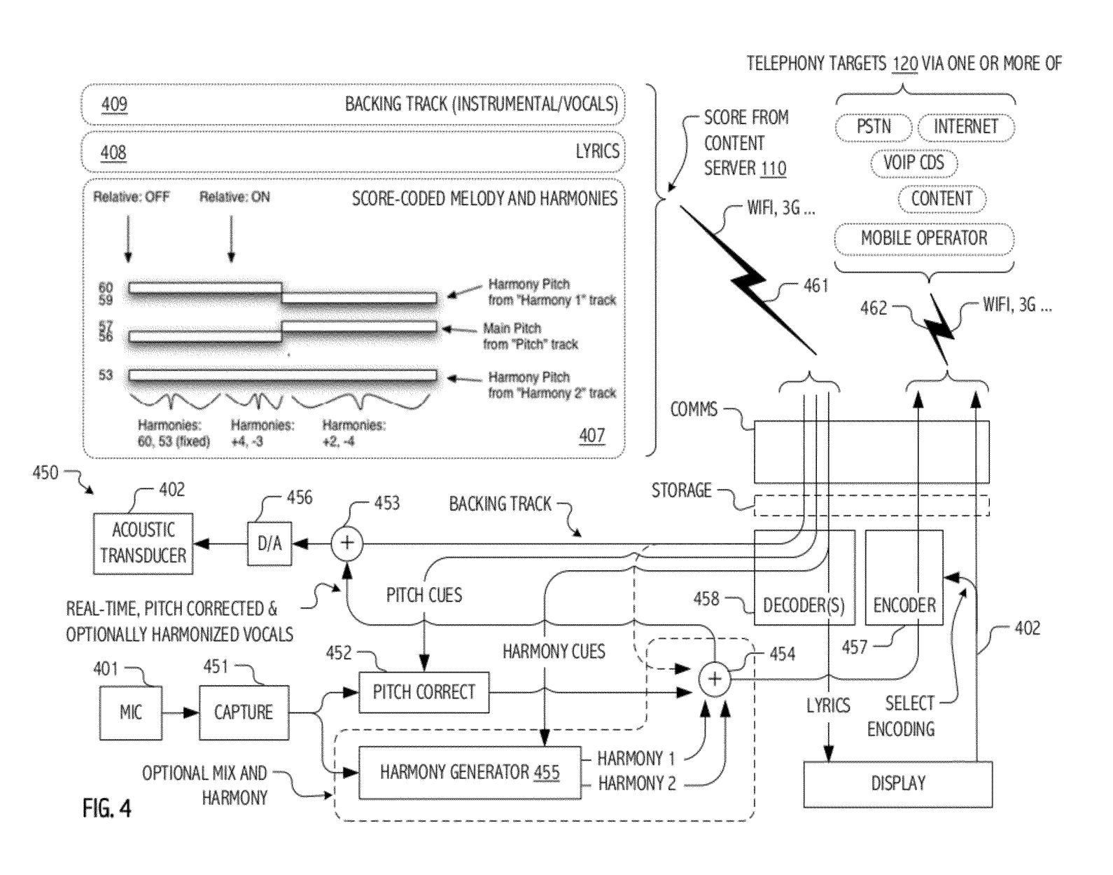

FIG. 4 is a flow diagram illustrating real-time continuous score-coded pitch-correction and harmony generation for a captured vocal performance in accordance with some embodiments of the present invention. As previously described as well as in the illustrated configuration, a user/vocalist sings along with a backing track karaoke style. Vocals captured (451) from a microphone input 401 are continuously pitch-corrected (452) and optionally harmonized (455) in real-time for mix (453) with the backing track which is audibly rendered at one or more acoustic transducers 402.

As will be apparent to persons of ordinary skill in the art, it is generally desirable to limit feedback loops from transducer(s) 402 to microphone 401 (e.g., through the use of head- or earphones). Indeed, while much of the illustrative description herein builds upon features and capabilities that are familiar in mobile phone contexts and, in particular, relative to the Apple iPhone handheld, even portable computing devices without a built-in microphone capabilities may act as a platform for vocal capture with continuous, real-time pitch correction and harmonization if headphone/microphone jacks are provided. The Apple iPod Touch handheld and the Apple iPad tablet are two such examples.

Both pitch correction and added harmonies are chosen to correspond to a score 407, which in the illustrated configuration, is wirelessly communicated (461) to the device (e.g., from content server 110 to an iPhone handheld 101 or other portable computing device, recall FIG. 1) on which vocal capture and pitch-correction is to be performed, together with lyrics 408 and an audio encoding of the backing track 409. One challenge faced in some designs and implementations is that harmonies may have a tendency to sound good only if the user chooses to sing the expected melody of the song. If a user wants to embellish or sing their own version of a song, harmonies may sound suboptimal. To address this challenge, relative harmonies are pre-scored and coded for particular content (e.g., for a particular song and selected portions thereof). Target pitches chosen at runtime for harmonies based both on the score and what the user is singing. This approach has resulted in a compelling user experience.

In some embodiments of techniques described herein, we determine from our score the note (in a current scale or key) that is closest to that sounded by the user/vocalist. While this closest note may typically be a main pitch corresponding to the score-coded vocal melody, it need not be. Indeed, in some cases, the user/vocalist may intend to sing harmony and sounded notes may more closely approximate a harmony track. In either case, pitch corrector 452 and/or harmony generator 455 may synthesize the other portions of the desired score-coded chord by generating appropriate pitch-shifted versions of the captured vocals (even if user/vocalist is intentionally singing a harmony). One or more of the resulting pitch-shifted versions may be optionally combined (454) or aggregated for mix (453) with the audibly-rendered backing track and/or wirelessly communicated (462) to content server 110 or a telephony target 120. In some cases, a user/vocalist can be off by an octave (male vs. female) or may simply exhibit little skill as a vocalist (e.g., sounding notes that are routinely well off key), and the pitch corrector 452 and harmony generator 455 will use the key/score/chord information to make a chord that sounds good in that context. In a capella modes (or for portions of a backing track for which note targets are not score-coded), captured vocals may be pitch-corrected to a nearest note in the current key or to a harmonically correct set of notes based on pitch of the captured vocals.

In some embodiments, a weighting function and rules are used to decide what notes should be “sung” by the harmonies generated as pitch-shifted variants of the captured vocals. The primary features considered are content of the score and what a user is singing. In the score, for those portions of a song where harmonies are desired, score 407 defines a set of notes either based on a chord or a set of notes from which (during a current performance window) all harmonies will choose. The score may also define intervals away from what the user is singing to guide where the harmonies should go.

So, if you wanted two harmonies, score 407 could specify (for a given temporal position vis-a-vis backing track 409 and lyrics 408) relative harmony offsets as +2 and −3, in which case harmony generator 455 would choose harmony notes around a major third above and a perfect fourth below the main melody (as pitch-corrected from actual captured vocals by pitch corrector 452 as described elsewhere herein). In this case, if the user/vocalist were singing the root of the chord (i.e., close enough to be pitch-corrected to the score-coded melody), these notes would sound great and result in a major triad of “voices” exhibiting the timbre and other unique qualities of the user's own vocal performance. The result for a user/vocalist is a harmony generator that produces harmonies which follow his/her voice and give the impression that harmonies are “singing” with him/her rather than being statically scored.

In some cases, such as if the third above the pitch actually sung by the user/vocalist is not in the current key or chord, this could sound bad. Accordingly, in some embodiments, the aforementioned weighting functions or rules may restrict harmonies to notes in a specified note set. A simple weighting function may choose the closest note set to the note sung and apply a score-coded offset. Rules or heuristics can be used to eliminate or at least reduce the incidence of bad harmonies. For example, in some embodiments, one such rule disallows harmonies to sing notes less than 3 semitones (a minor third) away from what the user/vocalist is singing.

Although persons of ordinary skill in the art will recognize that any of a variety of score-coding frameworks may be employed, exemplary implementations described herein build on extensions to widely-used and standardized musical instrument digital interface (MIDI) data formats. Building on that framework, scores may be coded as a set of tracks represented in a MIDI file, data structure or container including, in some implementations or deployments:
a control track: key changes, gain changes, pitch correction controls, harmony controls, etc.
one or more lyrics tracks: lyric events, with display customizations
a pitch track: main melody (conventionally coded)
one or more harmony tracks: harmony voice 1, 2 . . . Depending on control track events, notes specified in a given harmony track may be interpreted as absolute scored pitches or relative to user's current pitch, corrected or uncorrected (depending on current settings).
a chord track: although desired harmonies are set in the harmony tracks, if the user's pitch differs from scored pitch, relative offsets may be maintained by proximity to the note set of a current chord.
   Building on the forgoing, significant score-coded specializations can be defined to establish run-time behaviors of pitch corrector 452 and/or harmony generator 455 and thereby provide a user experience and pitch-corrected vocals that (for a wide range of vocal skill levels) exceed that achievable with conventional static harmonies.

Turning specifically to control track features, in some embodiments, the following text markers may be supported:
Key: <string>: Notates key (e.g., G sharp major, g#M, E minor, Em, B flat Major, BbM, etc.) to which sounded notes are corrected. Default to C.
PitchCorrection: {ON, OFF}: Codes whether to correct the user/vocalist's pitch. Default is ON. May be turned ON and OFF at temporally synchronized points in the vocal performance.
SwapHarmony: {ON, OFF}: Codes whether, if the pitch sounded by the user/vocalist corresponds most closely to a harmony, it is okay to pitch correct to harmony, rather than melody. Default is ON.
Relative: {ON, OFF}: When ON, harmony tracks are interpreted as relative offsets from the user's current pitch (corrected in accord with other pitch correction settings). Offsets from the harmony tracks are their offsets relative to the scored pitch track. When OFF, harmony tracks are interpreted as absolute pitch targets for harmony shifts.
Relative: {OFF, <+/−N> . . . <+/−N>}: Unless OFF, harmony offsets (as many as you like) are relative to the scored pitch track, subject to any operant key or note sets.
RealTimeHarmonyMix: {value}: codes changes in mix ratio, at temporally synchronized points in the vocal performance, of main voice and harmonies in audibly rendered harmony/main vocal mix. 1.0 is all harmony voices. 0.0 is all main voice.
RecordedHarmonyMix: {value}: codes changes in mix ratio, at temporally synchronized points in the vocal performance, of main voice and harmonies in uploaded harmony/main vocal mix. 1.0 is all harmony voices. 0.0 is all main voice.

Chord track events, in some embodiments, include the following text markers that notate a root and quality (e.g., C min7 or Ab maj) and allow a note set to be defined. Although desired harmonies are set in the harmony track(s), if the user's pitch differs from the scored pitch, relative offsets may be maintained by proximity to notes that are in the current chord. As used relative to a chord track of the score, the term “chord” will be understood to mean a set of available pitches, since chord track events need not encode standard chords in the usual sense. These and other score-coded pitch correction settings may be employed furtherance of the inventive techniques described herein.

### Additional Effects

Further effects may be provided in addition to the above-described generation of pitch-shifted harmonies in accord with score codings and the user/vocalists own captured vocals. For example, in some embodiments, a slight pan (i.e., an adjustment to left and right channels to create apparent spatialization) of the harmony voices is employed to make the synthetic harmonies appear more distinct from the main voice which is pitch corrected to melody. When using only a single channel, all of the harmonized voices can have the tendency to blend with each other and the main voice. By panning, implementations can provide significant psychoacoustic separation. Typically, the desired spatialization can be provided by adjusting amplitude of respective left and right channels. For example, in some embodiments, even a coarse spatial resolution pan may be employed, e.g.,
Left signal=x*pan; and
Right signal=x*(1.0-pan),
   where 0.0≦pan≦1.0. In some embodiments, finer resolution and even phase adjustments may be made to pull perception toward the left or right.

In some embodiments, temporal delays may be added for harmonies (based either on static or score-coded delay). In this way, a user/vocalist may sing a line and a bit later a harmony voice would sing back the captured vocals, but transposed to a new pitch or key in accord with previously described score-coded harmonies. Based on the description herein, persons of skill in the art will appreciate these and other variations on the described techniques that may be employed to afford greater or lesser prominence to a particular set (or version) of vocals.

### Pitch Correction and Harmony Shifts, Generally

As will be appreciated by persons of ordinary skill in the art having benefit of the present description, pitch-detection and correction techniques may be employed both for correction of a captured vocal signal to a target pitch or note and for generation of harmonies as pitch-shifted variants of a captured vocal signal. FIGS. 3 and 4 illustrate basic signal processing flows (350, 450) in accord with certain implementations suitable for an iPhone™ handheld, e.g., that illustrated as mobile device 101, to generate pitch-corrected and optionally harmonized vocals for supply to, and audible rendering at, a remote telephony target 120.

Based on the description herein, persons of ordinary skill in the art will appreciate suitable allocations of signal processing techniques (sampling, filtering, decimation, etc.) and data representations to functional blocks (e.g., decoder(s) 352, digital-to-analog (D/A) converter 351, capture 253 and encoder 355) of a software executable to provide signal processing flows 350 illustrated in FIG. 3. Likewise, relative to the signal processing flows 450 and illustrative score coded note targets (including harmony note targets), persons of ordinary skill in the art will appreciate suitable allocations of signal processing techniques and data representations to functional blocks and signal processing constructs (e.g., decoder(s) 458, capture 451, digital-to-analog (D/A) converter 456, mixers 453, 454, and encoder 457) as in FIG. 4, implemented at least in part as software executable on a handheld or other portable computing device.

Building then on any of a variety of suitable implementations of the forgoing signal processing constructs, we turn to pitch detection and correction/shifting techniques that may be employed in the various embodiments described herein, including in furtherance of the pitch correction, harmony generation and combined pitch correction/harmonization blocks (354, 452 and 455) illustrated in FIGS. 3 and 4, respectively.

As will be appreciated by persons of ordinary skill in the art, pitch-detection and pitch-correction have a rich technological history in the music and voice coding arts. Indeed, a wide variety of feature picking, time-domain and even frequency-domain techniques have been employed in the art and may be employed in some embodiments in accord with the present invention. The present description does not seek to exhaustively inventory the wide variety of signal processing techniques that may be suitable in various design or implementations in accord with the present description; rather, we summarize certain techniques that have proved workable in implementations (such as mobile device applications) that contend with CPU-limited computational platforms.

Accordingly, in view of the above and without limitation, certain exemplary embodiments operate as follows:
1) Get a buffer of audio data containing the sampled user vocals.
2) Downsample from a 44.1 kHz sample rate by low-pass filtering and decimation to 22k (for use in pitch detection and correction of sampled vocals as a main voice, typically to score-coded melody note target) and to 11k (for pitch detection and shifting of harmony variants of the sampled vocals).
3) Call a pitch detector (PitchDetector::calculatePitch ( )), which first checks to see if the sampled audio signal is of sufficient amplitude and if that sampled audio isn't too noisy (excessive zero crossings) to proceed. If the sampled audio is acceptable, the calculatePitch( ) method calculates an average magnitude difference function (AMDF) and executes logic to pick a peak that corresponds to an estimate of the pitch period. Additional processing refines that estimate. For example, in some embodiments parabolic interpolation of the peak and adjacent samples may be employed. In some embodiments and given adequate computational bandwidth, an additional AMDF may be run at a higher sample rate around the peak sample to get better frequency resolution.
4) Shift the main voice to a score-coded target pitch by using a pitch-synchronous overlap add (PSOLA) technique at a 22 kHz sample rate (for higher quality and overlap accuracy). The PSOLA implementation (Smola::PitchShiftVoice( )) is called with data structures and Class variables that contain information (detected pitch, pitch target, etc.) needed to specify the desired correction. In general, target pitch is selected based on score-coded targets (which change frequently in correspondence with a melody note track) and in accord with current scale/mode settings. Scale/mode settings may be updated in the course of a particular vocal performance, but usually not too often based on score-coded information, or in an a capella or Freestyle mode based on user selections.
PSOLA techniques facilitate resampling of a waveform to produce a pitch-shifted variant while reducing aperiodic affects of a splice and are well known in the art. PSOLA techniques build on the observation that it is possible to splice two periodic waveforms at similar points in their periodic oscillation (for example, at positive going zero crossings, ideally with roughly the same slope) with a much smoother result if you cross fade between them during a segment of overlap. For example, if we had a quasi periodic sequence like:

| a | b | c | d | e | d | c | b | a | b | c | d.1 | e.2 | d.2 | c.1 | b.1 | a | b.1 | c.2 |
|---|---|---|---|---|---|---|---|---|---|---|---|---|---|---|---|---|---|---|
| 0 | 1 | 2 | 3 | 4 | 5 | 6 | 7 | 8 | 9 | 10 | 11 | 12 | 13 | 14 | 15 | 16 | 17 | 18 |

with samples {a, b, c, . . . } and indices 0, 1, 2, . . . (wherein the 0.1 symbology represents deviations from periodicity) and wanted to jump back or forward somewhere, we might pick the positive going c-d transitions at indices 2 and 10, and instead of just jumping, ramp:
(1*c+0*c), (d*7/8+(d.1)/8), (e*6/8+(e.2)*2/8)
until we reached (0*c+1*c.1) at index 10/18, having jumped forward a period (8 indices) but made the aperiodicity less evident at the edit point. It is pitch synchronous because we do it at 8 samples, the closest period to what we can detect. Note that the cross-fade is a linear/triangular overlap-add, but (more generally) may employ complimentary cosine, 1-cosine, or other functions as desired.
5) Generate the harmony voices using a method that employs both PSOLA and linear predictive coding (LPC) techniques. The harmony notes are selected based on the current settings, which change often according to the score-coded harmony targets, or which in Freestyle can be changed by the user. These are target pitches as described above; however, given the generally larger pitch shift for harmonies, a different technique may be employed. The main voice (now at 22k, or optionally 44k) is pitch-corrected to target using PSOLA techniques such as described above. Pitch shifts to respective harmonies are likewise performed using PSOLA techniques. Then a linear predictive coding (LPC) is applied to each to generate a residue signal for each harmony. LPC is applied to the main un-pitch-corrected voice at 11k (or optionally 22k) in order to derive a spectral template to apply to the pitch-shifted residues. This tends to avoid the head-size modulation problem (chipmunk or munchkinification for upward shifts, or making people sound like Darth Vader for downward shifts).
6) Finally, the residues are mixed together and used to re-synthesize the respective pitch-shifted harmonies using the filter defined by LPC coefficients derived for the main un-pitch-corrected voice signal. The resulting mix of pitch-shifted harmonies are then mixed with the pitch-corrected main voice.
7) Resulting mix is upsampled back up to 44.1k, mixed with the backing track (except in Freestyle mode) or an improved fidelity variant thereof buffered for handoff to audio subsystem for playback.

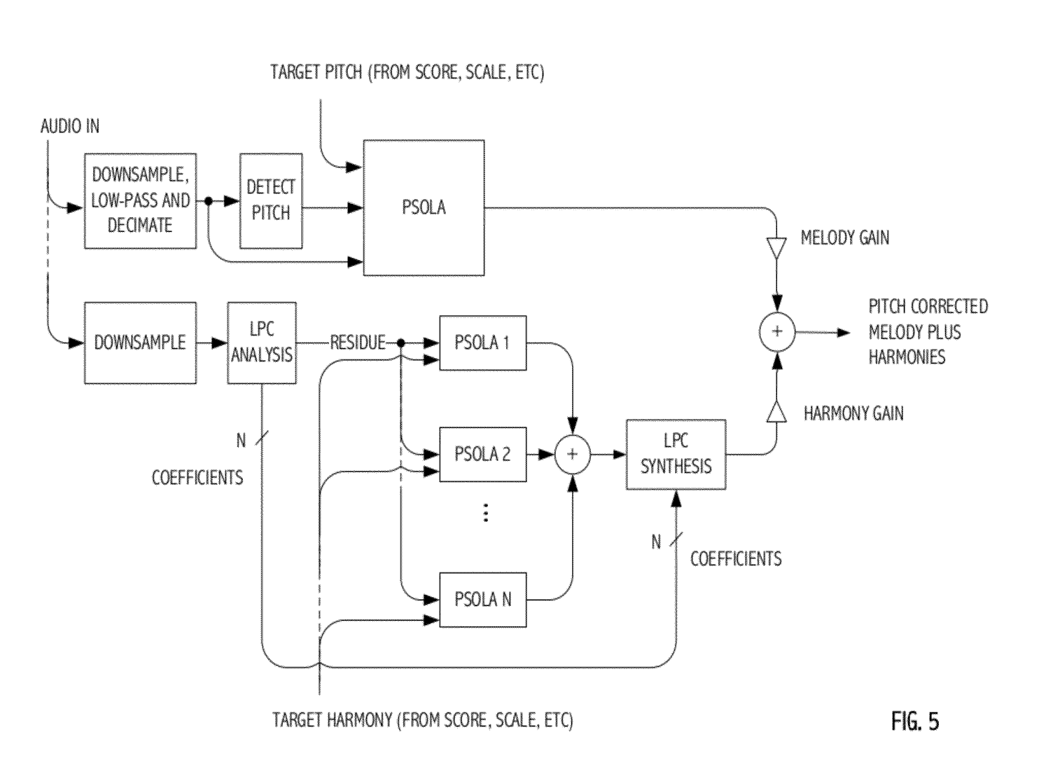

FIG. 5 presents, in flow diagrammatic form, one embodiment of the signal processing PSOLA LPC-based harmony shift architecture described above. Of course, function names, sampling rates and particular signal processing techniques applied are, of course, all matters of design choice and subject to adaptation for particular applications, implementations, deployments and audio sources.

As will be appreciated by persons of skill in the art, AMDF calculations are but one time-domain computational technique suitable for measuring periodicity of a signal. More generally, the term lag-domain periodogram describes a function that takes as input, a time-domain function or series of discrete time samples x(n) of a signal, and compares that function or signal to itself at a series of delays (i.e., in the lag-domain) to measure periodicity of the original function x. This is done at lags of interest. Therefore, relative to the techniques described herein, examples of suitable lag-domain periodogram computations for pitch detection include subtracting, for a current block, the captured vocal input signal x(n) from a lagged version of same (a difference function), or taking the absolute value of that subtraction (AMDF), or multiplying the signal by it's delayed version and summing the values (autocorrelation).

AMDF will show valleys at periods that correspond to frequency components of the input signal, while autocorrelation will show peaks. If the signal is non-periodic (e.g., noise), periodograms will show no clear peaks or valleys, except at the zero lag position. Mathematically,

AMDF(k)=Σₙ|x(n)−x(n−k)|

autocorrelation(k)=Σₙx(n)*x(n−k).

For implementations described herein, AMDF-based lag-domain periodogram calculations can be efficiently performed even using computational facilities of current-generation mobile devices. Nonetheless, based on the description herein, persons of skill in the art will appreciate implementations that build any of a variety of pitch detection techniques that may now, or in the future become, computational tractable on a given target device or platform.

### An Exemplary Mobile Device

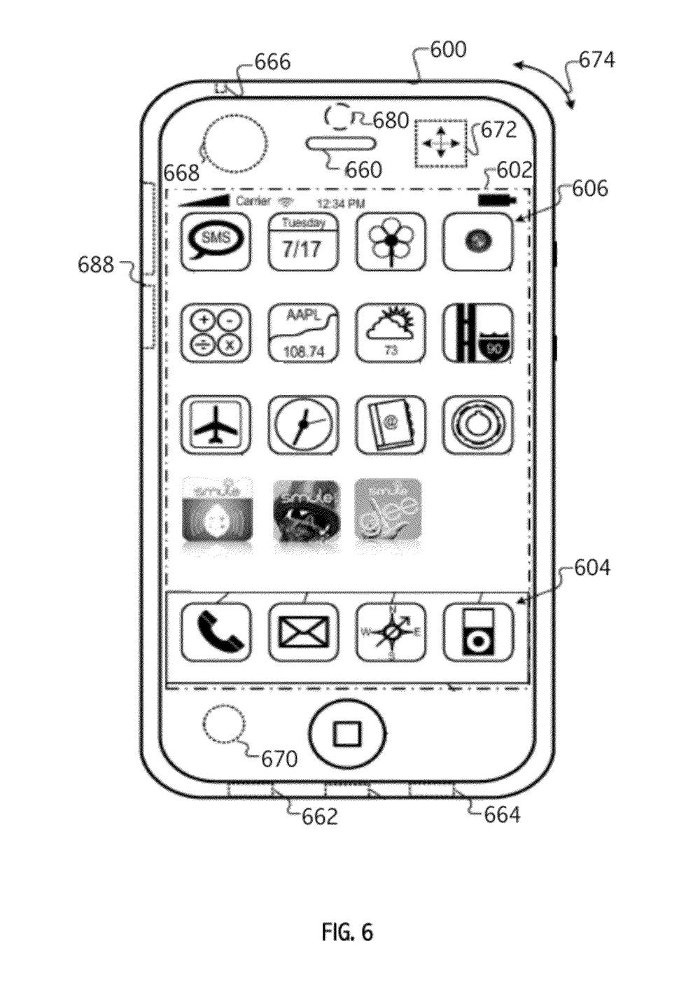

FIG. 6 illustrates features of a mobile device that may serve as a platform for execution of software implementations in accordance with some embodiments of the present invention. More specifically, FIG. 6 is a block diagram of a mobile device 600 that is generally consistent with commercially-available versions of an iPhone™ mobile digital device. Although embodiments of the present invention are certainly not limited to iPhone deployments or applications (or even to iPhone-type devices), the iPhone device, together with its rich complement of sensors, multimedia facilities, application programmer interfaces and wireless application delivery model, provides a highly capable platform on which to deploy certain implementations. Based on the description herein, persons of ordinary skill in the art will appreciate a wide range of additional mobile device platforms that may be suitable (now or hereafter) for a given implementation or deployment of the inventive techniques described herein.

Summarizing briefly, mobile device 600 includes a display 602 that can be sensitive to haptic and/or tactile contact with a user. Touch-sensitive display 602 can support multi-touch features, processing multiple simultaneous touch points, including processing data related to the pressure, degree and/or position of each touch point. Such processing facilitates gestures and interactions with multiple fingers, chording, and other interactions. Of course, other touch-sensitive display technologies can also be used, e.g., a display in which contact is made using a stylus or other pointing device.

Typically, mobile device 600 presents a graphical user interface on the touch-sensitive display 602, providing the user access to various system objects and for conveying information. In some implementations, the graphical user interface can include one or more display objects 604, 606. In the example shown, the display objects 604, 606, are graphic representations of system objects. Examples of system objects include device functions, applications, windows, files, alerts, events, or other identifiable system objects. In some embodiments of the present invention, applications, when executed, provide at least some of the digital acoustic functionality described herein.

Typically, the mobile device 600 supports network connectivity including, for example, both mobile radio and wireless internetworking functionality to enable the user to travel with the mobile device 600 and its associated network-enabled functions. In some cases, the mobile device 600 can interact with other devices in the vicinity (e.g., via Wi-Fi, Bluetooth, etc.). For example, mobile device 600 can be configured to interact with peers or a base station for one or more devices. As such, mobile device 600 may grant or deny network access to other wireless devices.

Mobile device 600 includes a variety of input/output (I/O) devices, sensors and transducers. For example, a speaker 660 and a microphone 662 are typically included to facilitate audio, such as the capture of vocal performances and audible rendering of backing tracks and mixed pitch-corrected vocal performances as described elsewhere herein. In some embodiments of the present invention, speaker 660 and microphone 662 may provide appropriate transducers for techniques described herein. An external speaker port 664 can be included to facilitate hands-free voice functionalities, such as speaker phone functions. An audio jack 666 can also be included for use of headphones and/or a microphone. In some embodiments, an external speaker and/or microphone may be used as a transducer for the techniques described herein.

Other sensors can also be used or provided. A proximity sensor 668 can be included to facilitate the detection of user positioning of mobile device 600. In some implementations, an ambient light sensor 670 can be utilized to facilitate adjusting brightness of the touch-sensitive display 602. An accelerometer 672 can be utilized to detect movement of mobile device 600, as indicated by the directional arrow 674. Accordingly, display objects and/or media can be presented according to a detected orientation, e.g., portrait or landscape. In some implementations, mobile device 600 may include circuitry and sensors for supporting a location determining capability, such as that provided by the global positioning system (GPS) or other positioning systems (e.g., systems using Wi-Fi access points, television signals, cellular grids, Uniform Resource Locators (URLs)) to facilitate geocodings described herein. Mobile device 600 can also include a camera lens and sensor 680. In some implementations, the camera lens and sensor 680 can be located on the back surface of the mobile device 600. The camera can capture still images and/or video for association with captured pitch-corrected vocals.

Mobile device 600 can also include one or more wireless communication subsystems, such as an 802.11b/g communication device, and/or a Bluetooth™ communication device 688. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc. A port device 690, e.g., a Universal Serial Bus (USB) port, or a docking port, or some other wired port connection, can be included and used to establish a wired connection to other computing devices, such as other communication devices 600, network access devices, a personal computer, a printer, or other processing devices capable of receiving and/or transmitting data. Port device 690 may also allow mobile device 600 to synchronize with a host device using one or more protocols, such as, for example, the TCP/IP, HTTP, UDP and any other known protocol.

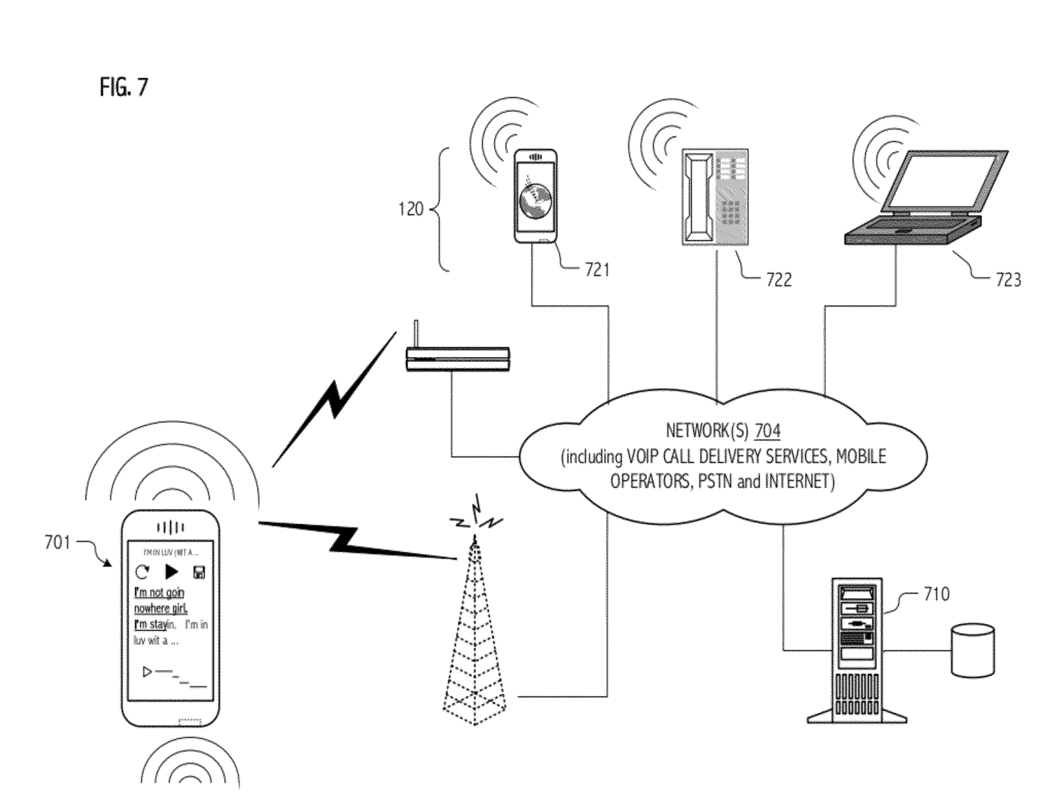

FIG. 7 illustrates an instance (701) of a portable computing device such as mobile device 600 programmed with user interface code, pitch correction code, an audio rendering pipeline and playback code in accord with the functional descriptions herein. Device instance 701 operates in a vocal capture and continuous pitch correction mode and supplies pitch corrected vocals to one or more telephony devices 120 (e.g., a second instance 721 of programmed mobile device 600, voice terminal 722, VoIP enabled computer 723 and/or any associated or associable network-resident or hosted call delivery services). Illustrated devices communicate (and data described here is communicated therebetween) using any suitable wireless data (e.g., carrier provided mobile services, such as GSM, 3G, CDMA, WCDMA, 4G, 4G/LTE, etc. and/or WiFi, WiMax, etc.) including any intervening networks 704 using facilities (exemplified as server 710) or a service platform that hosts storage and/or functionality explained herein with regard to content server 110, 210A, 210B (recall FIGS. 1, 2A, 2B, 3 and 4).

### Other Embodiments

While the invention(s) is (are) described with reference to various embodiments, it will be understood that these embodiments are illustrative and that the scope of the invention(s) is not limited to them. Many variations, modifications, additions, and improvements are possible. For example, while pitch correction vocal performances captured in accord with a karaoke-style interface have been described, other variations will be appreciated. Furthermore, while certain illustrative signal processing techniques have been described in the context of certain illustrative applications, persons of ordinary skill in the art will recognize that it is straightforward to modify the described techniques to accommodate other suitable signal processing techniques and effects.

Embodiments in accordance with the present invention may take the form of, and/or be provided as, a computer program product encoded in a machine-readable medium as instruction sequences and other functional constructs of software, which may in turn be executed in a computational system (such as a iPhone handheld, mobile device or portable computing device) to perform methods described herein. In general, a machine readable medium can include tangible articles that encode information in a form (e.g., as applications, source or object code, functionally descriptive information, etc.) readable by a machine (e.g., a computer, computational facilities of a mobile device or portable computing device, etc.) as well as tangible storage incident to transmission of the information. A machine-readable medium may include, but is not limited to, magnetic storage medium (e.g., disks and/or tape storage); optical storage medium (e.g., CD-ROM, DVD, etc.); magneto-optical storage medium; read only memory (ROM); random access memory (RAM); erasable programmable memory (e.g., EPROM and EEPROM); flash memory; or other types of medium suitable for storing electronic instructions, operation sequences, functionally descriptive information encodings, etc.

In general, plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the invention(s).

What is claimed is:

1. A method comprising:
at a portable computing device, audibly rendering a first encoding of backing audio and, concurrently with said audible rendering, capturing and pitch correcting a vocal performance of a user; and
transmitting from the portable computing device to a remote server, via a wireless data communications interface, both (i) an audio encoding of the pitch corrected vocal performance and (ii) a particular voice telephony line identifier to which the pitch corrected vocal performance is to be subsequently supplied.

2. The method of claim 1, further comprising:
at the remote server, mixing the pitch corrected vocal performance with a second encoding of the backing audio to produce a mixed performance for supply to the particular voice telephony line.

3. The method of claim 1, further comprising:
at the portable computing device and prior to the transmitting, mixing the pitch corrected vocal performance with the first encoding of the backing audio to produce a mixed performance version of the audio encoding for supply to the particular voice telephony line.

4. The method of claim 1, further comprising:
at the portable computing device, capturing user interface gestures selective for an audio snippet or effect; and
including in the transmitting from the portable computing device to a remote server (iii) an identifier for the selected audio snippet or effect keyed to a temporal position in the audio encoding.

5. The method of claim 1, further comprising:
at the portable computing device, capturing user interface gestures selective for an audio snippet or effect; and
mixing with, and including in, the transmitted audio encoding the selected audio snippet or effect at a temporal position consistent with the user interface gesture selection.

6. The method of claim 2, further comprising:
from the remote server, initiating call delivery to the particular voice telephony line using the mixed performance as audio content of the to be delivered call.

7. The method of claim 6, further comprising delivering the audio content to one or more of:
voice terminal equipment;
a wireless telephony device; and
an answering machine or information service using a telephone number or alphanumeric subscriber identifier.

8. The method of claim 6, further comprising:
delivering the audio content to telco or premises-based telephony equipment for supply as a ringback tone for calls subsequently initiated to the telephony target.

9. The method of claim 2, further comprising:
from the remote server, uploading the mixed performance for subsequent rendering as a ring-back tone in a telephone call incoming from the particular voice telephony line as calling party.

10. The method of claim 9,
wherein the subsequent rendering as a ring-back tone is by a switch servicing either or both of a called party and the particular voice telephony line as calling party.

11. The method of claim 10,
wherein the called party is a user of the portable computing device.

12. The method of claim 1, further comprising:
initiating a text or multimedia message to the particular voice telephony line, the text or multimedia message including a resource locator by which the mixed performance may be retrieved by a recipient thereof.

13. The method of claim 1, further comprising:
at the remote server, transcoding the audio encoding transmitted from the portable computing device into a p-law or A-law PCM encoding format suitable for interchange with a public switched telephone network (PSTN) switch.

14. The method of claim 1, further comprising:
at the portable computing device and prior to the transmitting, transcoding the audio encoding into a p-law or A-law PCM encoding format suitable for interchange with a public switched telephone network (PSTN) switch.

15. The method of claim 1, further comprising:
at the remote server, transcoding the audio encoding transmitted from the portable computing device into an encoding format suitable for interchange with a voice over internet protocol (VoIP) call delivery service.

16. The method of claim 1, further comprising:
at the portable computing device and prior to the transmitting, transcoding the audio encoding into an encoding format suitable for interchange with a voice over internet protocol (VoIP) call delivery service.

17. The method of claim 1, further comprising:
as a preview and prior to the subsequent supply, audibly rendering at the portable computing device a first mix of the pitch corrected vocal performance with either the first or the second encoding of the backing track.

18. The method of claim 1, further comprising:
via the data communications interface, retrieving settings for the pitch correction.

19. The method of claim 18,
wherein the retrieved settings for the pitch correction include pitch correction settings characteristic of a particular artist.

20. The method of claim 18,
wherein the retrieved settings for the pitch correction include performance synchronized temporal variations in pitch correction settings synchronized with backing audio.

21. The method of claim 18,
wherein the retrieved settings for the pitch correction include score-coded note targets.

22. The method of claim 1, further comprising:
retrieving via the data communications interface either or both of (i) the first encoding of the backing audio and (ii) lyrics and timing information associated with the backing audio; and
concurrent with the audible rendering, presenting corresponding portions of the lyrics on a display of the portable computing device in accord with the timing information.

23. The method of claim 1, further comprising:
receiving and audibly rendering a first mixed performance at the portable computing device, wherein the first mixed performance is an encoding of the pitch corrected vocal performance mixed with the higher quality or fidelity second encoding of the backing audio.

24. The method of claim 1, wherein the backing audio is selected from the group of:
a backing track of instrumentals and/or vocals; and
a backing track of ambient sounds reminiscent of a place other that in which the portable computing device presently resides.

25. The method of claim 1, wherein the portable computing device is selected from the group of:
a mobile phone;
a personal digital assistant; and
a laptop computer, notebook computer, pad-type device or netbook.

26. The method of claim 1, wherein the audio encoding is transmitted with additional media content such as video.

27. A computer program product encoded in one or more media, the computer program product including instructions executable on a processor of the portable computing device to cause the portable computing device to perform the method of claim 1.

28. The computer program product of claim 27, wherein the one or more media constitute storage readable by the portable computing device.

29. The computer program product of claim 27, wherein the one or more media constitute storage readable by the portable computing device incident to a computer program product conveying transmission to the portable computing device.

30. A portable computing device comprising:
a display; a microphone interface; an audio transducer interface; a data communications interface;
media content storage coupled to receive via the data communication interface, and to thereafter supply for audible rendering via the audio transducer interface, a first encoding of backing audio;
continuous pitch correction code executable on the portable computing device to, concurrent with said audible rendering, pitch correct a vocal performance of a user captured using the microphone interface; and
user interface code executable on the portable computing device to capture user interface gestures selective for a particular voice telephony line identifier to which the pitch corrected vocal performance is to be supplied and to thereafter initiate transmission of an audio encoding of the pitch corrected vocal performance.

31. The portable computing device of claim 30, further comprising:
transmit code executable on the portable computing device to effectuate the transmission via the data communications interface, the transmission including both (i) the particular voice telephony line identifier and (ii) the audio encoding for subsequent supply to the particular voice telephony line.

32. The portable computing device of claim 31,
wherein the transmission is to a remote server configured to subsequently supply the pitch corrected vocal performance to the particular voice telephone line.

33. The portable computing device of claim 31,
wherein the transmission is to a voice over internet protocol (VoIP) call delivery service.

34. The portable computing device of claim 31,
wherein the transmission includes a transcoding of the audio encoding into a μ-law or A-law PCM encoding format suitable for interchange with a public switched telephone network (PSTN) switch.

35. The portable computing device of claim 31,
wherein the transmission initiates or requests provisioning of a switch servicing either or both of a called party and the particular voice telephony line as calling party, the provisioning causing the switch to supply the audio encoding as a ring-back tone in a telephone call incoming from the particular voice telephony line as the calling party.

36. The portable computing device of claim 30, further comprising:
the user interface code executable to capture user gestures selective for an audio snippet or effect; and
audio mixing code executable on the portable computing device to mix with, and include in, the transmitted audio encoding the selected audio snippet or effect at a temporal position consistent with the user interface gesture selection.

37. The portable computing device of claim 31,
wherein the user interface code is executable to capture user gestures selective for an audio snippet or effect; and
wherein the transmission includes (iii) an identifier for the selected audio snippet or effect keyed to a temporal position in the audio encoding.

38. The portable computing device of claim 30, further comprising:
audio mixing code executable on the portable computing device to mix with, and include in, the transmitted audio encoding, the backing audio.

39. A method comprising:
using a portable computing device for vocal performance capture, the handheld computing device having a display, a microphone interface and a data communications interface;
retrieving from the data communications interface, either or both of a first encoding of backing audio and (ii) lyrics and timing information associated with the backing audio;
audibly rendering the first encoding of backing audio and, concurrently with said audible rendering, capturing and pitch correcting a vocal performance of a user; and
transmitting via the data communications interface, both (i) an audio encoding of the pitch corrected vocal performance and (ii) a particular voice telephony line identifier to which the pitch corrected vocal performance is to be subsequently supplied.

40. The method of claim 39, further comprising:
prior to the transmitting, mixing the pitch corrected vocal performance with the first encoding of the backing audio to produce a mixed performance version of the audio encoding for supply to the particular voice telephony line.

41. The method of claim 39, further comprising:
at the portable computing device, capturing user interface gestures selective for an audio snippet or effect; and
including in the transmission (iii) an identifier for the selected audio snippet or effect keyed to a temporal position in the audio encoding.

42. The method of claim 39, further comprising:
at the portable computing device, capturing user interface gestures selective for an audio snippet or effect; and
mixing with, and including in, the transmitted audio encoding the selected audio snippet or effect at a temporal position consistent with the user interface gesture selection.

43. The method of claim 39, further comprising:
at the portable computing device and prior to the transmitting, transcoding the audio encoding into a p-law or A-law PCM encoding format suitable for interchange with a public switched telephone network (PSTN) switch.

44. The method of claim 39,
wherein the transmitting is to a remote server configured to subsequently supply the pitch corrected vocal performance to the particular voice telephone line.

45. The method of claim 39,
wherein the transmitting is to a voice over internet protocol (VoIP) call delivery service.

46. The method of claim 39,
wherein the transmission initiates or requests provisioning of a switch servicing either or both of a called party and the particular voice telephony line as calling party, the provisioning causing the switch to supply the audio encoding as a ring-back tone in a telephone call incoming from the particular voice telephony line as the calling party.

47. A method comprising:
retrieving via a data communications interface of a portable computing device, either or both of a first encoding of backing audio and (ii) lyrics and timing information associated with the backing audio;
at the portable computing device, audibly rendering the first encoding of backing audio and, concurrently with said audible rendering, capturing and pitch correcting a vocal performance of a user; and
via the data communications interface, transmitting to a telephony target selected by the user, an audio encoding of the pitch corrected vocal performance.

48. The method of claim 47,
wherein the transmitting to the telephony target is performed concurrently with the capturing and pitch correcting the vocal performance.

49. The method of claim 47,
wherein the transmitting is via a remote server configured to subsequently supply the pitch corrected vocal performance to the telephony target.
